(19) United States
(12) Patent Application Publication
(10) Pub. No.: US 2009/0104046 A1
(43) Pub. Date: Apr. 23, 2009

(54) ROTARY PRESSURE TRANSFER DEVICES

(75) Inventors: Jeremy MARTIN, Berkeley, CA (US); Richard L. STOVER, Oakland, CA (US)

Correspondence Address: FITCH EVEN TABIN AND FLANNERY, 120 SOUTH LASALLE STREET, SUITE 1600, CHICAGO, IL, 60603-3406, US

(73) Assignee: Energy Recovery, Inc., San Leandro, CA (US)

(21) Appl. No.: 12/338,759

(22) Filed: Dec. 18, 2008

Related U.S. Application Data
(63) Continuation of application No. PCT/US2007/071740, filed on Jun. 21, 2007.
(60) Provisional application No. 60/806,174, filed on Jun. 29, 2006.

(51) Int. Cl. F04F 13/00; F04F 1/06; F15B 3/00

(52) U.S. Cl. 417/65; 417/103; 417/375; 417/405

(57) ABSTRACT

A rotary pressure exchange device for transferring the pressure of a high pressure stream of first fluid to a low pressure stream of second fluid having an improved substantially cylindrical rotor (41, 51, 61). The rotor is formed to provide a plurality of longitudinal passageways comprising the lumens (49) of parallel tubes (47, 73) of circular cross-section which are located uniformly throughout an annular region. Certain preferred embodiments include an outer tubular casing (43) of circular cross-section and a coaxial central hub (45).

This application is a continuation of International Application No. PCT/US2007/071740, filed 21 Jun. 2007 and claims priority from U.S. Provisional Application No. 60/806,174, filed Jun. 29, 2006, the disclosures of which are incorporated herein by reference.

### FIELD OF THE INVENTION

The invention relates to rotary pressure transfer devices where a first fluid under a high pressure hydraulically communicates with a second, lower pressure, fluid, and transfers pressure between the fluids producing a high pressure discharge stream of the second fluid. More particularly, the invention relates to such rotary pressure transfer devices having rotors of improved designs and method for making same.

### BACKGROUND OF INVENTION

Many industrial processes, especially chemical processes, operate at elevated pressures. These processes often require a high pressure fluid feed, which may be a gas, a liquid or a slurry, and they produce a fluid product or effluent. One way of providing a high pressure fluid feed to such an industrial process is by feeding a relatively low pressure feed stream through a pressure transfer device to exchange pressure between a high pressure stream to be discharged or stored and the low pressure feed stream. One particularly efficient type of pressure transfer device utilizes a rotor having a plurality of axial channels wherein hydraulic communication between the high pressure fluid and the low pressure feed fluid is established in alternating sequences.

U.S. Pat. Nos. 4,887,942; 5,338,158; 6,537,035; 6,540,487; 6,659,731 and 6,773,226 illustrate rotary pressure transfer devices of the general type described herein for transferring pressure energy from one fluid to another. The operation of this type of device is a direct application of Pascal's Law: “Pressure applied to an enclosed fluid is transmitted undiminished to every portion of the fluid and to the walls of the containing vessel.” Pascal's Law holds that, if a high pressure fluid is brought into hydraulic contact with a low pressure fluid, the pressure of the high pressure fluid becomes reduced, while the pressure of the low pressure fluid is increased, and such pressure exchange is accomplished with minimum mixing. A rotary pressure transfer device of the type of present interest applies Pascal's Law by alternately and sequentially (1) bringing an axial channel which contains a first lower pressure fluid into hydraulic contact with an entrance chamber for a second higher pressure fluid, thereby pressurizing the first fluid within the channel and causing an amount of first fluid that was in the channel to exit in a volumetric extent equal to that of the higher pressure second fluid which takes its place, and thereafter (2) bringing the same channel into hydraulic contact with a second entrance chamber at the opposite end of the channel containing the incoming stream of first lower pressure fluid which de-pressurizes the fluid then in the channel, reducing its pressure to about that of an incoming stream of first fluid and causing discharge of a similar volumetric amount of the second fluid which is now at such lower pressure.

The net result of the pressure transfer process, in accordance with Pascal's Law, is to cause the pressures of the two fluids to approach each other. In a chemical process, such as seawater reverse osmosis which may, for example, operate at high pressures, e.g., 700-1200 pounds per square inch gauge (psig), where a seawater feed may generally be available at a low pressure, e.g., atmospheric pressure to about 50 psig, there will likely also be a high pressure brine stream available from the process at about 650-1150 psig. By feeding the low pressure seawater feed stream and the high pressure brine discharge stream to such a rotary pressure transfer device, the seawater can be advantageously pressurized while depressurizing the waste brine. The advantageous effect of using the rotary pressure transfer device in such an industrial process is a very substantial reduction in the amount of high pressure pumping capacity needed to raise the seawater feed stream to the high pressure desired for efficient operation; this can often result in an energy reduction of up to 65% for such a process and a corresponding reduction in required pump size.

In such a rotary pressure transfer device, there is generally a rotor with a plurality of parallel, open-ended channels. The rotor may be driven by an external force, but it is preferably driven by the directional entry of the high pressure fluid into the channels, as known in this art. Rotation effects alternating hydraulic communication of the fluid in one channel exclusively with an incoming higher pressure first fluid entering from an entrance chamber at one end, and then, a very short interval later, exclusively with an incoming lower pressure second fluid entering from an entrance chamber at the other end. The result is axially countercurrent flow of fluids being alternately effected in each channel of the rotor, creating two discharge streams, for example a greatly reduced pressure brine stream and a greatly increased pressure feed stream of seawater.

In such a rotary pressure transfer device having such a rotating rotor, there will be many, very brief intervals of hydraulic communication, between each of the plurality of channels extending substantially longitudinally through the rotor in an axial direction and entrance and exit chambers at the opposite ends of the device, for supplying and discharging such first and second fluids, which chambers are otherwise hydraulically isolated from each other. Minimal mixing occurs within the channels because operation is such that each channel will have a zone of relatively dead fluid that serves as a buffer or interface between the two fluids; moreover, each fluid will enter and exit from one respective end of the rotor. As a result, the high pressure brine discharge stream can transfer its pressure to the incoming low pressure seawater feed stream with negligible mixing.

The rotor usually rotates in a surrounding cylindrical sleeve or housing, with its flat, axial end faces slidingly and sealingly interfacing with end covers wherein inlet and discharge passageways are formed. These end covers are usually peripherally supported by contact with the surrounding sleeve, and each will have such separate inlet and discharge passageways for alternately mating/aligning with the channels in the rotor. The rotor is often supported by a hydrodynamic bearing and, as mentioned above, may be driven by the flow of fluids entering the rotor channels. To achieve extremely low friction, the device usually does not use separate fixed seals, but it instead uses fluid seals and fluid bearings, with extremely close tolerances being employed to minimize leakage. As these longitudinal channels alternately align and hydraulically connect with opposite pairs of inlet and discharge passageways in the end covers, they partially fill with, for example, an incoming high pressure brine stream at one end and then with an incoming low pressure seawater stream at the other end; in both instances, there is discharge of a similar volume of liquid from the opposite end of the channel. As the rotor rotates between these intervals of alternate hydraulic communication, the channels are briefly sealed off from communication with the openings in either of the two end covers.

In rotary pressure transfer devices of this general type, the cylindrical rotor is one very important component, and there are advantages in maximizing the total volume of the longitudinal channels in a rotor and in simplifying the construction thereof. Accordingly, improved rotor constructions have continued to be sought.

### SUMMARY OF THE INVENTION

Whereas present day, commercial pressure transfer devices employ a rotor of solid ceramic or other material having, for example, twelve channels of generally pie-shaped cross sections extending longitudinally therethrough (such as that shown in FIG. 2), it has been found that rotors can be constructed where the total cross-sectional area of the longitudinal channels is very substantially and advantageously increased and for which construction and potential maintenance costs are reduced. Instead of providing a plurality of parallel longitudinally extending passageways in a block of solid material, the rotor can advantageously be constructed using a plurality of parallel tubes. If desired, the rotor construction can be such that there are active flow channels both within the interiors or lumens of each of the tubes and in the arcuate regions between adjacent tubes. Moreover, in instances where damage to a rotor might occur, such a basically tubular construction should often allow repair to be carried out where needed by removal and replacement of a single tube rather than a need to re-machine an entire rotor block.

In one particular aspect, the invention provides in a rotary pressure transfer device wherein a substantially cylindrical rotor having a plurality of channels extending longitudinally therethrough revolves about its axis in a cavity between a pair of end covers that sealingly interface with opposite flat ends of the rotor, and wherein a high pressure first fluid and a low pressure second fluid are supplied to opposite ends of the rotor through passageways in said end covers resulting in the simultaneous filling with and discharge of fluids through passageways in the opposite end covers, the improvement which comprises an annular assembly of a plurality of juxtaposed individual tubes that are mutually interconnected with one another as a part of a rotor which has a plurality of flow channels that extend end to end thereof.

In another particular aspect, the invention provides a rotary pressure transfer device which comprises a substantially cylindrical rotor having a plurality of channels extending longitudinally therethrough, means for mounting said rotor so that it revolves about a central longitudinal axis or hub between a pair of end covers that sealingly interface with opposite flat ends of the rotor in which there are openings into said channels, means for supplying a high pressure first fluid to one said end cover at one end of said rotor, means for supplying a low pressure second fluid to said end cover at the opposite end of the rotor, and said end covers each having inlet and discharge passageways that extend therethrough, and said rotor comprising a plurality of juxtaposed parallel individual tubes which essentially fill the annular region between said hub and said outer tubular casing, whereby entry of one fluid into each said channel at one end of the revolving rotor results in the simultaneous discharge of the other fluid from the opposite end of said channel through outlet passageways in the opposite end cover.

### BRIEF DESCRIPTION OF THE DRAWINGS

FIG. 1 is a front view of a prior art pressure transfer device of this general type, shown in cross section, which uses a rotor that rotates about a central axis.

FIG. 2 is an enlarged perspective view of a typical prior art rotor that might be used in the FIG. 1 device.

FIG. 2A is a front view of the upper end cover in the pressure exchanger illustrated in FIG. 1.

FIG. 3 is a perspective view of a first embodiment of a rotor embodying various advantageous features.

FIG. 4 is an enlarged exploded perspective view of an alternative embodiment of such a rotor.

FIG. 5 is a view similar to FIG. 3 of a further alternative embodiment of such a rotor.

### DETAILED DESCRIPTION OF THE PREFERRED EMBODIMENTS

Shown in FIG. 1 is a rotary pressure transfer device of a type as generally described in U.S. Pat. No. 6,540,487, which incorporates certain details of the rotary device illustrated in U.S. Pat. No. 7,201,557, issued Apr. 10, 2007, the disclosures of both of which are incorporated herein by reference. The device includes a body 11 having a cavity wherein a substantially cylindrical rotor 13 having an open-ended axial chamber rotates within a surrounding tubular sleeve 15. A pair of upper and lower end covers 17, 19 have inward surfaces that interface with flat end faces of the rotor, with liquid seals being established at the two interfaces. When such a sleeve is used, the end covers, rotor and sleeve are preferably installed or removed as a unit through the incorporation of a central tension rod 21 which unites the upper and lower end covers with the sleeve 15 that provides a defined cylindrical cavity within which the rotor 13 rotates. Alternatively, the sleeve may be omitted, and the rotor designed to revolve about a central axle of some type.

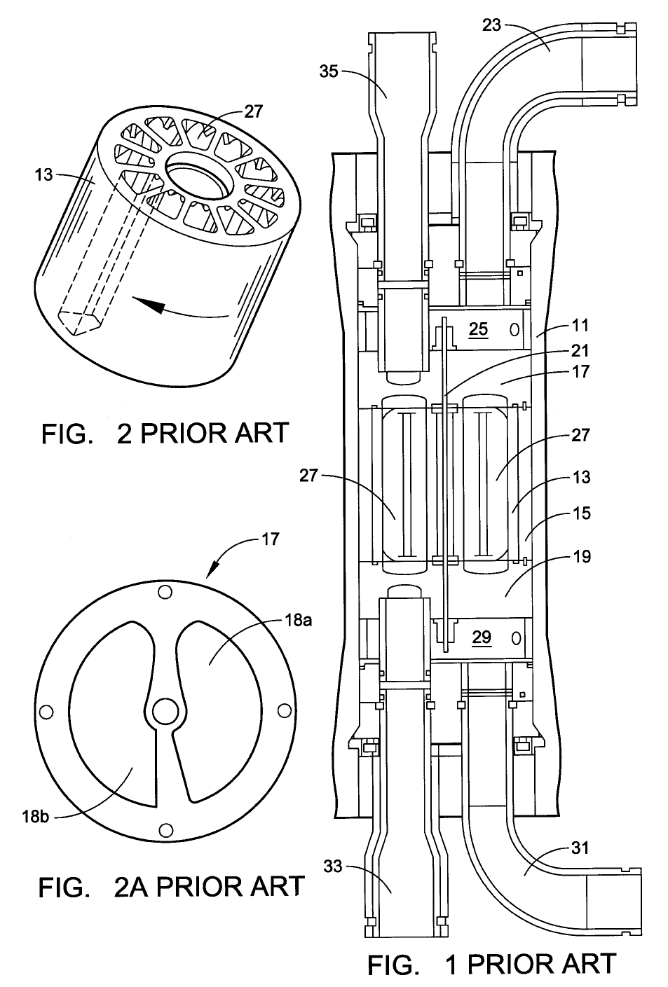

In the illustrated prior art device of FIGS. 1, 2 and 2A, inlets to and outlets from the interior cavity of the device are provided at each end of the housing. During operation, for example in a reverse osmosis water purification process, a high pressure brine from an RO separation system may be fed into the high pressure elbow inlet 23 at the upper end where it fills an upper plenum chamber 25 and a high pressure, inlet passageway that extends through the end cover 17 to an angular or generally crescent-shaped opening 18a having a radially oriented flat edge in its inward flat surface 17a from which high pressure liquid will flow into longitudinal channels 27 within the rotor 13 that become aligned therewith (see FIGS. 2 and 2A). Such high pressure liquid inflow simultaneously pressurizes and displaces the liquid already in the channel, discharging it at the opposite end through a high pressure discharge passageway in the lower end cover 19 that leads to a lower plenum 29, from which the now pressurized seawater feed stream exits via a high pressure elbow outlet 31.

As the rotor 13 revolves, this channel 27 next moves into alignment with an inlet passageway in the lower end cover 19 that is connected to a low pressure seawater feed inlet conduit 33 at the lower end of the body, depressurizing the liquid then in the channel. At its upper end, the channel becomes simultaneously aligned with a similarly shaped opening 18b to an outlet passageway in the upper end cover 17 that leads to a low pressure liquid discharge conduit 35 at the top of the device. As a result, low pressure seawater flows into the channel from the bottom and discharges brine through the straight conduit 35 at the top. Thus, in each complete revolution of the rotor 13, each channel 27 will pressurize and discharge an amount of seawater that has been raised to high pressure, equal to about 50% to 90% of the total volume of that channel, and each is then refilled with low pressure seawater that will then be pressurized and discharged during the next revolution.

In FIG. 3, one preferred embodiment of a rotor 41 is illustrated wherein a tubular outer casing 43 and a tubular inner casing 45 are coaxially arranged in combination with an assembly of individual small tubes 47 to provide what is termed a substantially cylindrical rotor open at its center axis. An inner casing 45 and an outer casing 43 are employed in the preferred embodiment; however, one or both of these casings may be omitted by appropriately sizing the tubes so that that innermost circle of tubes constitutes the inner boundary of the rotor and the outermost circle of tubes constitutes the outer boundary. For example, if the optional outer casing is omitted, it would still be considered a substantially cylindrical rotor as each of the tubes in the outer circle of tubes might be in line contact with and slide along the interior surface of a sleeve 15 as the rotor revolves. Such an alternative annular rotor might then be made of a similar plurality of tubes 47 arranged in juxtaposed position with one another, so that each tube is touching at least two other tubes. These tubes of the same diameter are arranged so as to essentially fill the annular region between the casings so that the maximum number of tubes of the same outer diameter are included. The tubes 47 in both of these rotor constructions are preferably interconnected at locations along their lengths, for example, by welding throughout their entire length of contact if made of metal or adhesively if the tubes are made of metal or a composite material. Such lengthwise interconnections would seal what might otherwise be undesirable transverse flow or leakage passageways between tubes. For example, the rotor might be fabricated, using a suitable jig, as a tube assembly, either with or without the inner casing 45. By interconnecting the juxtaposed tubes along their entire lengths, the generally star-shaped passageways between tubes are sealed at their longitudinal edges so these passageways can function as closed channels in the pressure exchange device, and there will not be any significant leakage flow from the region of high pressure channels to the generally diametrically opposite region of low pressure channels. If the inclusion of an outer casing 43 is desired, the resultant tube assembly may then be installed in such an outer casing 43. If both outer and inner casings are used, they might even be interconnected by radial struts (not shown) to further improve overall rigidity and assure the two casings remain coaxial. The tubes have sidewalls of such thickness and are sized so that the totality of the cross-sectional area of the flow channels is equal to at least about 70% and preferably at least about 80% of the cross-sectional area of the annular region. With the inclusion of the preferred inner casing 45, revolution may be about some type of axle with the inner casing as a hub, and, if desired, a sleeve 15 need not be used.

In this rotor arrangement, both the interior cylindrical regions or lumens 49 of the tubes 47 and the generally star-shaped, arcuate, interstitial regions 50 between adjacent tubes serve as liquid flow channels. Accordingly, when the rotor 41 revolves in the cylindrical cavity within the outer sleeve 15 and a channel becomes at least partially aligned with the inlet passageway opening in the upper end cover 17, for example, high pressure brine pressurizes the liquid in the channel and flows into this end of each channel; because in the FIG. 3 rotor 41 there are always about the same volume of channels that are aligned with the inlet passageway opening in the upper end cover 17 at one time, inlet flow of such liquid through the passageway is continuous and substantially constant. This is in contrast to other commercial devices where there are minor variations to the overall rate of inlet flow, as each channel achieves full alignment and is then followed by a wall section of substantial area located between it and the next channel. This substantially continuous rate of liquid flow into the rotating channels reduces vibrations and potential cavitation, and it also increases the total volume of the second liquid, i.e. seawater, that is simultaneously being discharged at its higher pressure from the outlet 31 for each revolution of the rotor. Accordingly, this construction offers significant advantages. The radial locations of the inlet and outlet passageways in the upper and lower end covers are preferably such that they do not extend past the centerlines of the tubes in the innermost circle and the outermost circle of tubes, particularly when an inner casing or an outer casing is not employed, so that there would be no liquid flow respectively in the arcuate regions radially inward of or radially outward of the surfaces of the tubes in these two circles.

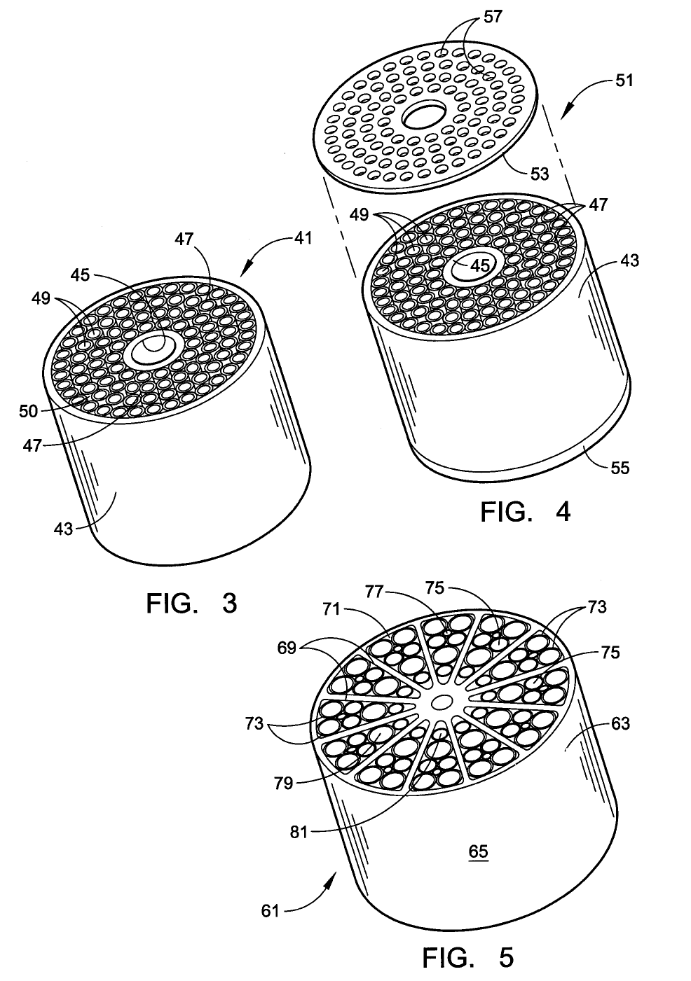

Another embodiment of a rotor 51 is depicted in FIG. 4 that is, in many ways, similar to that just described with respect to FIG. 3. In its preferred construction, it likewise includes two coaxial casings 43, 45, which radially flank an annular assembly of a plurality of parallel individual tubes 47 that are similarly in line contact with one another. The difference lies in the addition of a pair of parallel, upper and lower flat face plates 53, 55 that have flat interior surfaces which respectively abut the flat ends of the tubes 47. The plates may be welded or adhesively or otherwise suitably joined to the tubes to create an integral structure. For example, the undersurface of each face plate might be coated with a thin layer of epoxy resin that would create a seal to each of the tubes and the casings. The bundle of tubes 47 thus similarly fills the annular region of the rotor body between the coaxial casings 43, 45 as explained hereinbefore. A plurality of circular apertures 57 in each face plate, which are of equal diameter with the cylindrical passageways or lumens 49 through the tubes, are in alignment so that they are concentric with each of the tubes. In this construction, the total cross sectional area of the circular apertures 57 may reasonably equal at least about 50% of the annular region between the casings 43, 45 and at least about 40% of the surface area of one of the face plates. Again, in this construction the inner casing 43 and/or the outer casing 45 might be omitted, in which case the circular edges of the upper face plate 53 and the lower face plate 55 might revolve in sliding contact with the cylindrical interior of the sleeve 15 in such an operating device while still constituting a substantially cylindrical rotor.

As a further alternative to the FIG. 4 construction, tubes 47 of slightly smaller diameters and slightly longer in length could be located on centers such that they are slightly spaced from one another, as opposed to being in longitudinal line contact, and the face plate openings 57 could be bored to receive the ends of the tubes 47. This construction would allow one or more tubes to be replaced in a straightforward manner and would also facilitate their construction from different materials, e.g. ceramic end plates and fiber composite tubes. As a still further alternative, the ends of the tubes 47 might be received in counterbores provided in the undersurface of each face plate that would be provided in surrounding relationship to each of these circular apertures 57; such would create a very stable rotor structure. In either of the last two alternatives, the employment of the inner casing 43 and/or the outer casing 45 would again be optional. In such alternative embodiments where the tubes are spaced apart from one another, they then would not be mutually supporting; however, the tubes would be mutually interconnected through these circular plates to which they would be affixed. The rigidity provided by the flat upper and lower circular face plates 53, 55 would still provide the desired rigidity for effective rotor operation.

In the FIG. 4 arrangement and in the alternatives mentioned just above, there is a further advantage of the flat outer surfaces of such face plates 53, 55. The greater and essentially continuous surface area provided by the face plates assures an effective liquid seal is maintained at the interface between the flat face plates of the rotor and the respective inward flat surfaces of the end covers; thus, it may be preferred for this reason.

In the prior art, each of the rotor ducts is instantly pressurized or depressurized to the amount of its full contents when it moves into alignment with the openings in the end covers, as can be seen from FIGS. 2 and 2A. In the designs exemplified in FIGS. 3 and 4, the rotor channels are divided into multiple smaller circular passageways that are positioned such that the center of each passageway is not always precisely aligned in the radial direction with the center of another passageway. The tubes in FIGS. 3 and 4 essentially occupy concentric circles around the inner casing or hub. These concentric rings of tubes are staggered so that the lumen of a tube in the outer ring will become pressurized or depressurized an instant before or an instant after the lumens of the tubes located generally radially inward thereof in the inner concentric rings. As a result, the pressure transition events that occurred 12 times per rotation in the prior art are divided into many dozens of smaller events. This reduces overall pressure fluctuations which, in turn, reduces vibration and noise.

As earlier indicated, when a channel 27 in the rotor 13 of FIG. 2, filled with essentially atmospheric pressure liquid, moves into alignment with the opening 18a to the high pressure brine inflow passageway which may be at 1,000 psig, there is a very substantial pressure change or pulsation. Another such pressure change subsequently occurs when the high pressure liquid in the channel next moves into alignment with the opening 18b to the discharge passageway for the brine in the upper end cover 17 and the inflow passageway opening in the lower end cover.

A further alternative embodiment of a rotor 61 is depicted in FIG. 5 where a shell or body 63 is provided in the form of an outer tubular casing 65 which is connected to an inner hub 67 by a plurality of radially extending walls 69 that divide the annular region into a plurality of pie-shaped compartments 71, e.g. twelve. Each of the twelve compartments 71 constitutes an about 30° segment of the circular cross-section of the rotor 61, and a plurality of individual tubes of varying sizes are spatially arranged in each of the pie-shaped compartments in a repetitive pattern about the rotor. Tubes of such varying diameter are chosen which are proportioned so as to occupy a high percentage of the pie-shaped region. In the illustrated embodiment, two fairly large diameter tubes 73, arranged side-by-side, occupy the radially outwardmost portion of each compartment, and two tubes 75 of smaller diameter are located side-by-side just radially inward of the outermost two tubes 73. One small diameter tube 77 is located in the arcuate region between these four juxtaposed tubes. A single, large diameter tube 79 is then disposed next radially inward thereof, and a smaller diameter tube 81 and is located at the radially inwardmost region of the compartment 71 and completes the 7-tube arrangement. The totality of the flow channel cross-sectional area is equal to at least abut 70% and preferably at least about 80% of the cross-sectional area of the annular region. Inasmuch as the large diameter tubes 79 are in abutting contact with both radial walls 69 of each compartment, the innermost tubes 81 might be omitted without sacrificing stability. If desired, a pair of face plates, similar to the plates 53, 55, could be attached that would have openings aligned with the lumens of the tubes.

Thus, this FIG. 5 arrangement retains some compartmented flow regions, and as a result of the longitudinally extending walls 69 that define the compartments 71, it provides a particularly rigid overall structure. At the same time, it retains certain desirable features of the FIG. 3 embodiment where both the lumens and the arcuate interstices between adjacent tubes constitute flow channels in the rotor 61 which increases the total pumped volume and reduces pulsations in the rate of pumping flow. Moreover, this construction would also permit replacement of any individual tube in the rotor should such suffer damage or corrosion.

Although the invention has been described with regard to certain preferred embodiments which constitute the best mode known to the inventor for carrying out this invention, it should be understood that various changes and modifications as would be obvious to one skilled in the art may be made without departing from the scope of this invention which is defined by the claims appended hereto.

1. In a rotary pressure transfer device wherein a substantially cylindrical rotor having a plurality of channels extending longitudinally therethrough revolves about its axis in a cavity between a pair of end covers that sealingly interface with opposite flat ends of the rotor, and wherein a high pressure first fluid and a low pressure second fluid are supplied to opposite ends of the rotor through passageways in said end covers resulting in the simultaneous filling with and discharge of fluids through passageways in the opposite end covers, the improvement which comprises:
an annular assembly of a plurality of juxtaposed individual tubes that are mutually interconnected with one another as a part of a rotor which has a plurality of flow channels that extend end to end thereof.

2. The improvement according to claim 1 wherein all said individual tubes are of essentially the same diameter.

3. The improvement according to claim 2 wherein the total cross-sectional area of the lumens of said tubes is equal to at least about 40% of the cross-sectional area of said rotor.

4. The improvement according to claim 1 wherein said individual tubes are of circular cross-section and are disposed so that they are in contact with one another along longitudinal lines throughout their lengths.

5. The improvement according to claim 1 wherein said rotor has a tubular outer casing.

6. The improvement according to claim 5 wherein an outer circle of said individual tubes in said assembly are in contact with the interior surface of said outer tubular casing.

7. The improvement according to claim 5 wherein said rotor has an inner hub that is coaxial with said outer casing and said hub and casing radially flank said annular tube assembly.

8. The improvement according to claim 1 wherein said individual tubes have varying diameters, are arranged in a repeating pattern around said rotor and provide a plurality of longitudinal flow channels having a combined area in the lumens of the tubes and in the arcuate cross-sectional interstitial regions therebetween equal to at least about 80% of the total cross-sectional area of the annular region between said hub and said outer tubular casing.

9. The improvement according to claim 8 wherein a plurality of radial walls extend from said inner hub to said outer tubular casing, dividing said annular region into a plurality of pie-shape compartments that are annular segments having essentially the same size, and wherein a plurality of said individual tubes of varying diameter are disposed within each of said annular segments.

10. A rotary pressure transfer device which comprises:
a substantially cylindrical rotor having a plurality of channels extending longitudinally therethrough,
means for mounting said rotor so that it revolves about a central longitudinal axis between a pair of end covers that sealingly interface with opposite flat ends of the rotor in which there are openings into said channels,
means for supplying a high pressure first fluid to one said end cover at one end of said rotor, and
means for supplying a low pressure second fluid to said end cover at the opposite end of the rotor,
said end covers each having inlet and discharge passageways that extend therethrough, and
said rotor comprising a plurality of juxtaposed parallel individual tubes which essentially fill an annular region thereof which will be aligned with said inlet and discharge passageways of said end covers during revolution,
whereby entry of one fluid into each said channel at one end of the revolving rotor results in the simultaneous discharge of the other fluid from the opposite end of said channel through outlet passageways in the opposite end cover.

11. The device according to claim 10 wherein said individual tubes are of circular cross-section and are disposed in contact with one another along longitudinal lines throughout their lengths.

12. The device according to claim 11 wherein all said individual tubes are of essentially the same diameter.

13. The device according to claim 10 wherein said rotor has a tubular outer casing and an interior coaxial hub.

14. The device according to claim 10 wherein said individual tubes are of circular cross-section and the total cross-sectional area of the lumens thereof is at least about 40% of the cross-sectional area of said rotor.

15. The device according to claim 10 wherein said individual tubes have varying circular diameters and are arranged about said rotor in a repeating pattern and provide a plurality of longitudinal flow channels having a combined cross-sectional area in the lumens of the tubes and in the arcuate interstitial regions therebetween equal to at least about 80% of the total cross-sectional area of the annular region between a central hub and a coaxial outer tubular casing.

16. The device according to claim 10 wherein a plurality of radial walls extend from said hub to said outer tubular casing, dividing said annular region into a plurality of compartments that are annular segments of essentially the same size and wherein a plurality of said individual tubes of varying diameter are disposed in like patterns within each of said annular segments.

17. A method of making a cylindrical rotor having a plurality of channels extending longitudinally therethrough for use in a rotary pressure transfer device wherein the rotor will revolve about its axis in a cavity between a pair of facing end covers having flat faces with inlet and discharge passageways, and wherein a high pressure first fluid and a low pressure second fluid will be supplied to opposite ends of the rotor through passageways in said end covers so as to result in the simultaneous filling with and discharge of fluids through passageways in the opposite end covers, which method comprises:
providing an inner hub of circular cross section,
providing an outer casing of circular cross section and greater diameter, disposed coaxially in surrounding relationship to said hub,
filling the annular region between said hub and said casing with an assembly of a plurality of juxtaposed individual tubes that are mutually interconnected with one another to create a rotor having a plurality of flow channels that extend end to end thereof, and
providing flat, parallel end faces on said rotor which are perpendicular to said axis, which flat end faces will sealingly interface with the facing end covers.

18. The method according to claim 17 wherein said individual tubes are of circular cross-section and essentially the same diameter and are disposed so that they are in contact with one another along longitudinal lines throughout their lengths.

19. The method according to claim 18 wherein said hub is a tubular inner casing and an inner circle of said tubes is in contact with the outer surface of said inner casing throughout the lengths of said tubes.

20. The method according to claim 19 wherein said tubes which are in contact with one another and are joined along longitudinal lines to seal one to another throughout their entire lengths and thereby eliminate potential transverse leakage passageways in said rotor.
